(19) United States
(12) Patent Application Publication
(10) Pub. No.: US 2007/0255741 A1
(43) Pub. Date: Nov. 1, 2007

(54) APPARATUS AND METHOD FOR MERGING METADATA WITHIN A REPOSITORY

(75) Inventors: Wolfgang Ernst GEIGER, Ashland, OR (US); Awez SYED, San Jose, CA (US)

Correspondence Address: COOLEY GODWARD KRONISH LLP;ATTN: Patent Group, Suite 500, 1200 - 19th Street, NW, Washington, DC, 20036-2402, US

(73) Assignee: BUSINESS OBJECTS, S.A., Levallois-Perret (FR)

(21) Appl. No.: 11/741,458

(22) Filed: Apr. 27, 2007

Related U.S. Application Data
(60) Provisional application No. 60/795,689, filed on Apr. 28, 2006.

(51) Int. Cl. G06F 7/00

(52) U.S. Cl. 707/101

(57) ABSTRACT

A computer readable storage medium includes executable instructions to create a database structure that contains groups of linked data tables to store different types of metadata selected from Business Metadata, Structural Metadata and Operational Metadata. At least two different types of metadata are received. The database structure is populated with the at least two different types of metadata to form composite metadata.

### CROSS REFERENCE TO RELATED APPLICATIONS

This application claims the benefit of U.S. Provisional Application Ser. No. 60/795,689, entitled “Apparatus And Method For Merging Metadata Within A Repository,” filed Apr. 28, 2006, the contents of which are hereby incorporated by reference in their entirety.

### BRIEF DESCRIPTION OF THE INVENTION

This invention relates generally to information processing. More particularly, this invention relates to dynamically generating a repository of composite metadata specifying relationships between business, structural and operational metadata.

### BACKGROUND OF THE INVENTION

Business Intelligence generally refers to software tools used to improve business enterprise decision-making. These tools are commonly applied to financial, human resource, marketing, sales, customer, and supplier analyses. More specifically, these tools can include reporting and analysis tools to present information, content delivery infrastructure systems to deliver and manage reports and analytics, data warehousing systems to cleanse and consolidate information from disparate sources, and database management systems (“DBMS”) that are used to organize, store, retrieve, and manage data in databases, such as relational, Online Transaction Processing (“OLTP”) and Online Analytic Processing (“OLAP”) databases.

Metadata (or data about data) exists in many different places within a business enterprise. Current systems to capture metadata tend to focus on metadata related to a specific segment of the metadata within the organization. For example, independent silos of metadata are often created by databases, modeling tools, Extract Transform Load (ETL) tools, and Business Intelligence tools. These tools lead to a proliferation of metadata, duplicate metadata, and different representations of the metadata. Thus, these tools do not produce metadata that can be easily combined to answer specific questions. In addition, these silos of metadata do not provide a single access point for the metadata. Viewing and understanding the metadata across the tools is nearly impossible as common elements are not detectable and it is hard to track usage of different elements or match elements since not all tools version metadata changes.

In current systems, relationships are not made between operational, structural and business metadata. Structural metadata is information that characterizes the physical arrangement, characteristics and/or accessibility of data. Structural metadata may include table names, column names, data types, source information, target information, mapping information, and versioning information. Structural metadata allows developers to build and improve a data source (e.g., a data warehouse).

Operational metadata is information that characterizes the utilization of a data source (e.g., a data warehouse). Operational metadata may include audit information, load times, data history, data quality information, table utilization information, table aggregation information, and table indices.

Business metadata is information that characterizes data that is manipulated in a Business Intelligence system. Business metadata may include business names from reports, universe objects, annotations, keywords, as well as data lineage, quality and freshness information. Business metadata allows users to effectively and correctly use the data in a data source.

Given the challenges in combining the metadata about various forms of data in an enterprise, Business Intelligence tools are not able to leverage this data effectively, consistently, or in combination in order to present an accurate picture of the limitations and lineage of the data.

### SUMMARY OF THE INVENTION

The invention includes a computer readable medium with executable instructions to create a database structure that contains groups of linked data tables to store different types of metadata selected from Business Metadata. Structural Metadata and Operational Metadata. At least two different types of metadata are received. The database structure is populated with the at least two different types of metadata to form composite metadata.

### BRIEF DESCRIPTION OF THE FIGURES

The invention is more fully appreciated in connection with the following detailed description taken in conjunction with the accompanying drawings, in which:

FIG. 1 illustrates a workflow associated with constructing a composite metadata store in accordance with one embodiment of the invention.

FIG. 2 illustrates the architecture and flow of data in one embodiment of the invention.

FIG. 3 illustrates a workflow associated with updating information in a composite metadata store associated with one embodiment of the invention.

FIG. 4 illustrates a workflow associated with another embodiment of the invention.

FIG. 5 illustrates a workflow associated with establishing data trustworthiness in accordance with an embodiment of the invention.

FIGS. 6-9 illustrate various graphical user interfaces for supplying data trustworthiness information in accordance with an embodiment of the invention.

Like reference numerals refer to corresponding parts throughout the several views of the drawings.

### DETAILED DESCRIPTION OF THE INVENTION

The following terminology is used to describe embodiments of the invention:

Business Metadata is information that characterizes data that is manipulated in a Business Intelligence system. Business metadata may include business names from reports, universe objects, annotations, keywords, as well as data lineage, quality and freshness information. Business metadata allows users to effectively and correctly use the data in a data source.

Structural Metadata is information that characterizes the physical arrangement, characteristics and/or accessibility of data. Structural metadata may include table names, column names, data types, source information, target information, mapping information, and versioning information. Structural metadata allows developers to build and improve a data source (e.g., a data warehouse).

Operational Metadata is information that characterizes the utilization of a data source (e.g., a data warehouse). Operational metadata may include audit information load times, data history, data quality information, table utilization information, table aggregation information, and table indices.

Data Integrator (DI) is an Extract, Transform and Load (ETL) tool sold by Business Objects Americas, San Jose, Calif., which supports aspects of the invention and acts as a potential metadata source.

Metadata Manager (MM) is the term used to describe the combination of metadata integrators and a metadata repository. Optionally, it also describes tools, such as the Metadata Manager Administrator tool and the Metadata Manager Explorer.

Metadata Manager Administrator is a software application and/or related Software Developer Kit (SDK) that provides an interface that enables a user to configure, schedule, set security for, and administer metadata integrators.

Metadata Manager Explorer is a software application and/or related SDK that provides an interface that enables a user to explore, search, and perform impact, lineage, and usage analyses on the metadata within a metadata repository. In one embodiment of the invention, the metadata manager explorer also provides administrative tools for configuring and scheduling metadata integrators, setting security, and the like.

Metadata Manager Repository is the metadata repository that is populated by the metadata integrators. The repository provides metadata from various metadata sources in a consistent structure with meaningful connections and relationships between the metadata elements. The Metadata Manager Repository also contains Metadata Manager related administrative information, such as integrator schedules, user logins, user preferences, and the like.

Metadata Integrator is a set of executable instructions, a program or a script that extracts metadata from a source and populates it in a metadata manager repository. Several types of Metadata Integrators are provided by Business Objects, San Jose, Calif. to populate the MM repository. Additional metadata integrators may be written by third parties and be installed in an MM system. A metadata integrator obtains metadata from a source system, processes it, and loads it into the MM repository along with discovered relationships.

Data Trustworthiness is a ranking of the trustworthiness of business and data objects based on either provided, user defined, or configured criteria. Data trustworthiness can be supplied as a value associated with a data point to an application, such as a reporting tool where it can be visually represented as contextual information about the data that is being provided.

Impact and Lineage are logical relationships that can be extrapolated based on the metadata characterizing relationships within the metadata manager repository.

Static metadata is information about objects that do not change during job execution (e.g., a software module, a data structure, etc.); this kind of information is versioned, i.e. the MM repository tracks changes to each object's state over time.

CMS is a repository server that stores information about a Business Intelligence server and the objects related to Business Intelligence (such as reports, data connections, server architecture, semantic layers, predefined business objects, queries, users, user groups, alerts, processing schedules and the like). The CMS can act as a metadata source.

A Report refers to information automatically retrieved (i.e., in response to computer executable instructions) from a data source (e.g., a database, a data warehouse, and the like), where the information is structured in accordance with a report schema that specifies the form in which the information should be presented. A non-report is an electronic document that is constructed without the automatic retrieval (i.e., in response to computer executable instructions) of information from a data source. Examples of non-report electronic documents include typical business application documents, such as a word processor document, a presentation document, and the like.

A report document is generally created by a specialized tool including executable instructions to access data and format it. A report document where the content does not include external data, either saved within the report or accessed live, is a template document for a report rather than a report document. Unlike, other non-report documents that may optionally import external data within a document, a report document by design is primarily a medium for accessing, formatting, and presenting external data.

A report design tool contains executable instructions specifically designed to facilitate working with external data sources. In addition to instructions regarding external data source connection drivers, these instructions may include advanced filtering of data, instructions for combining data from different external data sources, instructions for updating join structures and relationships in report data, and instructions including logic to support a more complex internal data model (that may include additional constraints, relationships, and metadata).

In contrast to a spreadsheet type application, a report generation tool is generally not limited to a table structure but can support a range of structures. A report design tool is designed primarily to support imported external data, whereas a spreadsheet application equally facilitates manually entered data and imported data. In both cases, a spreadsheet application applies a spatial logic that is based on the table cell layout within the spreadsheet in order to interpret data and perform calculations on the data. In contrast, a report design tool is not limited to logic that is based on the display of the data, but rather can interpret the data and perform calculations based on the original (or a redefined) data structure and meaning of the imported data. Spreadsheets applications work within a looping calculation model, whereas report generation tools may support a range of calculation models. Although there may be an overlap in the function of a spreadsheet document and a report document, the applications used to generate these documents contain instructions with different assumptions concerning the existence of an external data source and different logical approaches to interpreting and manipulating imported data.

Data, commonly manifested in reports, is critical to establishing business strategies and actions. Enterprises increasingly integrate data from a number of sources, such as different databases, external streaming data feeds, and personal spreadsheets. Once this data is integrated it is difficult to determine which values in a report come from which source. In addition, it is not clear how fresh the data may be or if there are validity issues with the data source. Because of these problems, currently, the value of reports may be questioned because of concerns regarding the accuracy of the underlying data.

Validation of data within a warehouse or specific data source can add some degree of confidence in the data. This validation, which may be in the form of metadata, is not passed to the report user in a clear and direct manner, so the validation information is often rendered useless in the report generation process.

Even if there are internal standards for evaluating the trustworthiness of a report, enterprise reporting systems do not effectively link this information with a report. In addition, establishing trust for a report document is often based on the currency (i.e., timeliness) of the data and other factors that may not be possible for a user to determine.

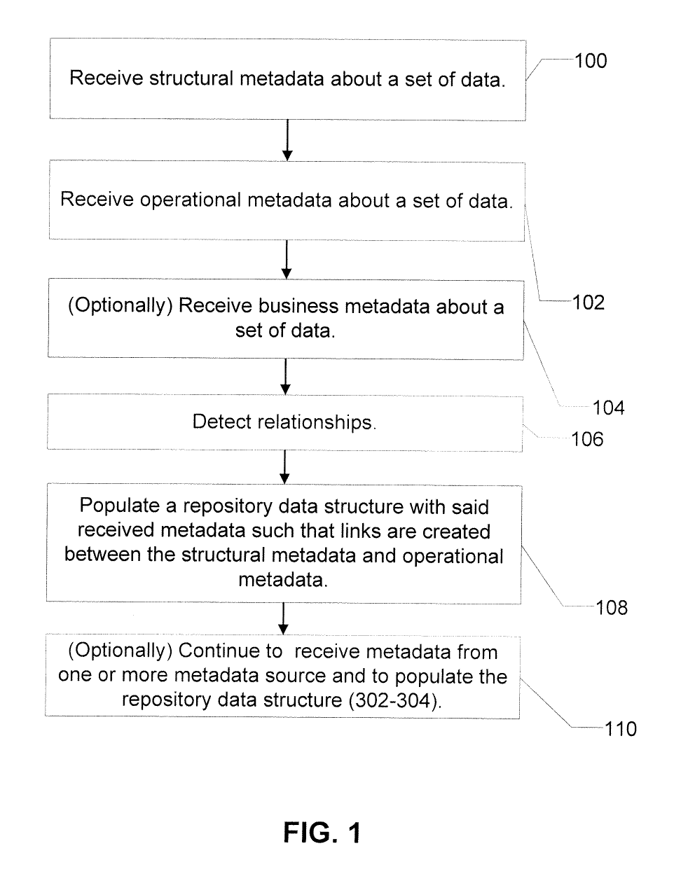

FIG. 1 illustrates processing associated with an embodiment of the invention. The repository receives structural metadata about a set of data 100 and operational metadata about a set of data 102. The sets of data may partially or fully correspond. Optionally, the repository receives business metadata about a set of data that may partially or fully correspond to the other sets of data 104. The metadata is passed to the repository by metadata integrators to obtain metadata from the source system, processes it, and load it, along with discovered relationships, into the MM repository.

Relationships between the sets of data are detected by the metadata integrators 106. This detection includes detecting a number of relationship types based on programmatically or manually defined relationships. A repository data structure is populated with the received metadata and the relationships between the data in the data sets such that links are created between the sets of metadata 108. These links may be based on defining relationship tables, the overall linking structure of the data structure, defining lookup tables and the like. Optionally, depending on the workflow, the repository continues to receive metadata from one or more metadata sources and to populate the repository data structure 110.

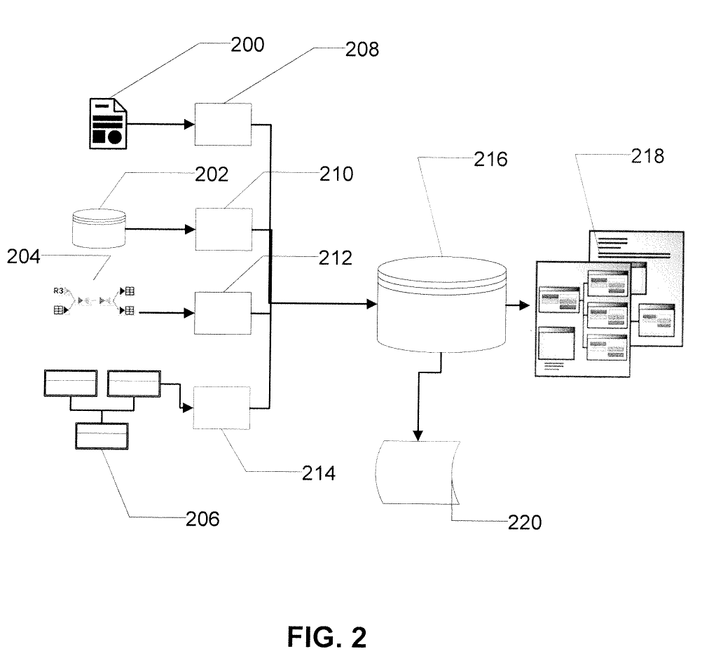

FIG. 2 illustrates the architecture and flow of data in one embodiment of the invention. Pre-existing metadata sources 200, 202, 204, and 206 may include Business Intelligence/Business Metadata systems 200, including reporting, EII (Enterprise Information Integration), Enterprise Information Management (EIM) and similar systems. Metadata sources may also include databases such as relational database management system (RDBMS) or online analytical processing (OLAP) databases 202, ETL tools 204, including Business Objects Data Integrator and other third party ETL tools, and Data modeling tools 206. Metadata integrators 208, 210, 212, and 214 are used to interface with the metadata sources 200-206 to extract consistent sets of metadata and detect and construct relationships in the metadata. These metadata integrators may be provided or may be defined using a public API (Application Program Interface). The metadata integrators 208-214 may be scheduled, run on demand, or run in conjunction with other administrative functions. In one embodiment of the invention, a GUI (Graphical User Interface) is provided to configure, schedule, and administer the metadata integrators. The metadata integrators write the metadata, the detected relationships, and logically constructed relationships to a metadata repository 216. The metadata repository provides the metadata about the metadata sources 200-206 in a logical structure, with consistent metadata content and meaningful relationships between the metadata data elements so that it is available to other tools. Thus, the metadata repository 216 represents composite metadata. The Metadata Manager Tool 218 enables the user to explore and search the composite metadata as well as view lineage, impact and usage data. Optionally, third party tools 220 may leverage the composite metadata stored in the metadata repository 216.

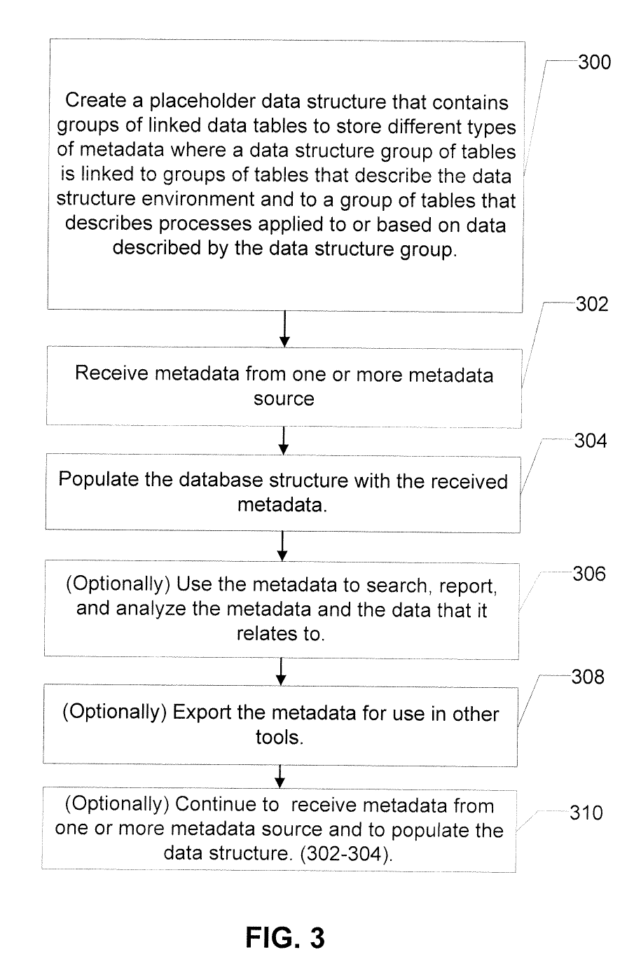

FIG. 3 illustrates a workflow associated with one embodiment of the invention. A place holder data structure is created that contains linked groups of tables to store different types of metadata, where groups of tables storing structural metadata are linked to groups of tables for metadata about the operational metadata 300. Metadata is received from one or more metadata sources 302 and the data structure is populated with this received metadata. Optionally, the metadata is used to search, report, and analyze the metadata and the data to which it relates 306. In one embodiment of the invention, a GUI tool Metadata Manager Explorer provides this functionality. Optionally, the metadata within the data structure can be exported for use in other tools 308. Optionally, the process continues and the data structure continues to be populated from one or more metadata sources 310.

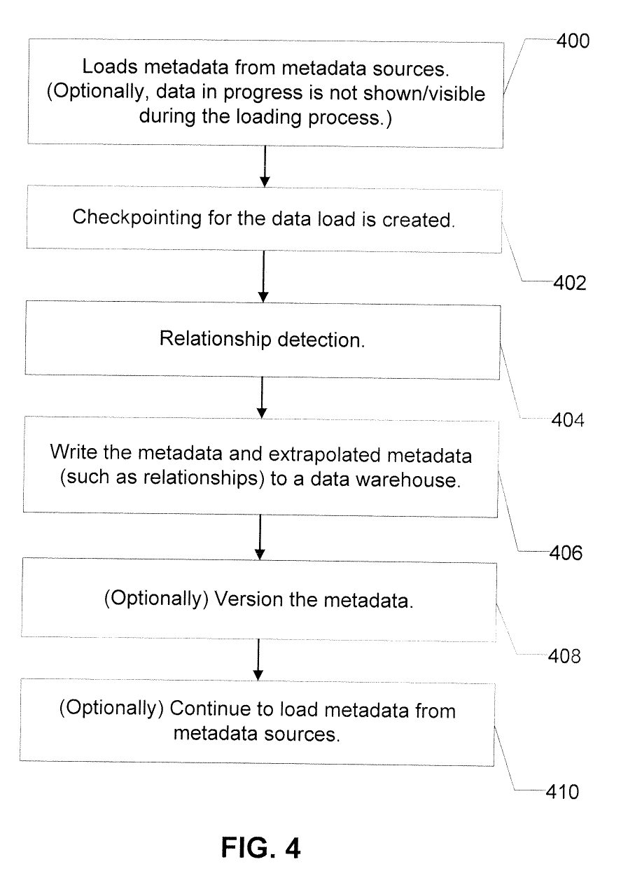

FIG. 4 illustrates a workflow associated with one embodiment of the invention. Metadata from data sources (metadata sources) is loaded 400. Optionally, locking is used such that the metadata in progress is not visible during the load process. Check pointing for the loaded metadata is created 402. Relationship detection occurs 404. The appendices provide information on relationship detection. The metadata and any extrapolated metadata such as relationships, resolution of aliases, and the like are written to the repository data warehouse 406. Optionally, the metadata is versioned 408 if it doesn't inherently contain datetime information 408. Optionally, the process continues and additional metadata is loaded from the metadata data sources 410.

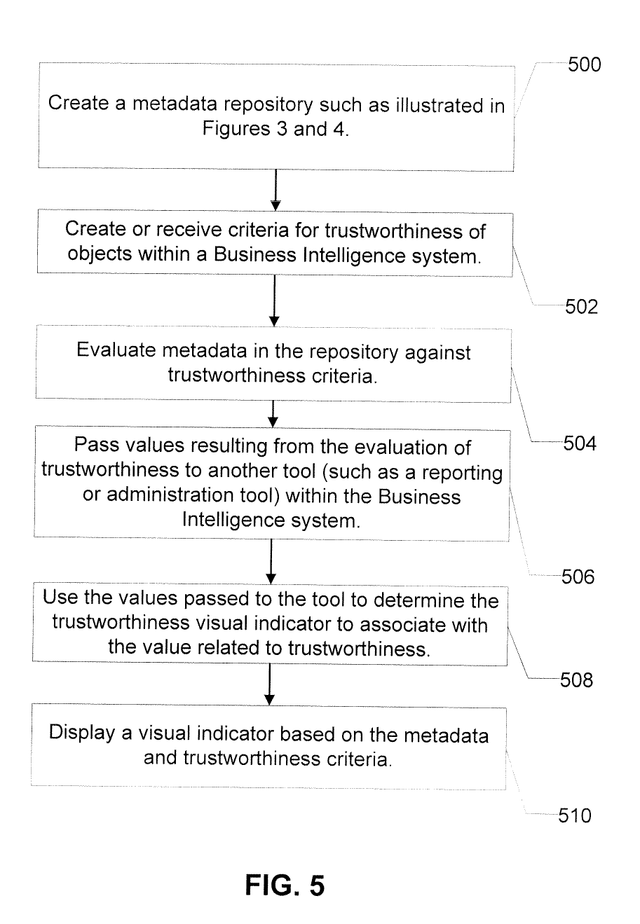

FIG. 5 illustrates a workflow associated with an embodiment of the invention where the metadata is used to determine trustworthiness of a data source, query, specific data value, report, semantic layer, ETL job, or any other aspect of a Business Intelligence system. The metadata repository is created, such as illustrated in FIGS. 3-4 500. Criteria for trustworthiness of objects or value items within a Business Intelligence system is either created or received 502. Metadata in the repository is evaluated against the trustworthiness criteria 504. Values resulting from the evaluation of the metadata against trustworthiness criteria are passed to another tool within the Business Intelligence System 506. This other tool could be related to Metadata Manager, such as Metadata Manager Administrator, Metadata Manager Explorer, and the like or this other tool can be a reporting application, ETL tool, EII tool, or any other tool/software application related to Business Intelligence systems. The value passed to the other tool is then used to determine which trustworthiness visual indicator the other tool will associate with the value (or object), where the relevant trustworthiness object has been evaluated 508. The other tool displays a visual indicator (such as highlighting/display color/or an icon) based on the metadata as it is evaluated against trustworthiness criteria 510. Trustworthiness evaluation techniques are disclosed in the patent application entitled “Apparatus and Method for Facilitating Trusted Business Intelligence”, Ser. No. 11/267,029, filed Nov. 4, 2005, the contents of which are incorporated herein by reference.

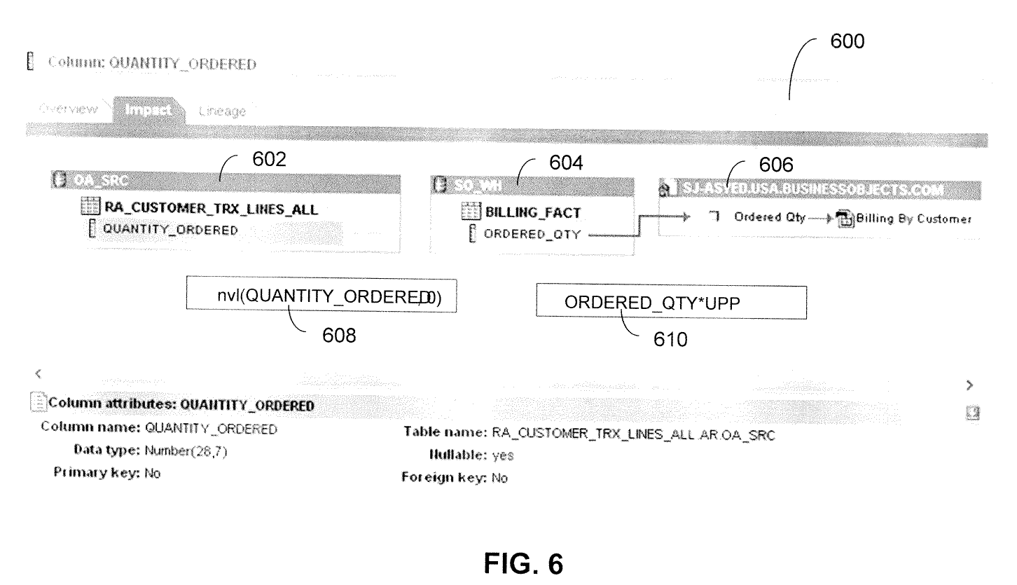

FIG. 6 illustrates a GUI 600 that may be used to display trustworthiness information. The GUI 600 provides information on a data source 602, a data transformation 604, and data delivery 606. Additional information 608 characterizing the data source may also be provided. Similarly, information 610 characterizing a data transformation may be provided. Thus, a user can more thoroughly understand the nature of the data that is presented.

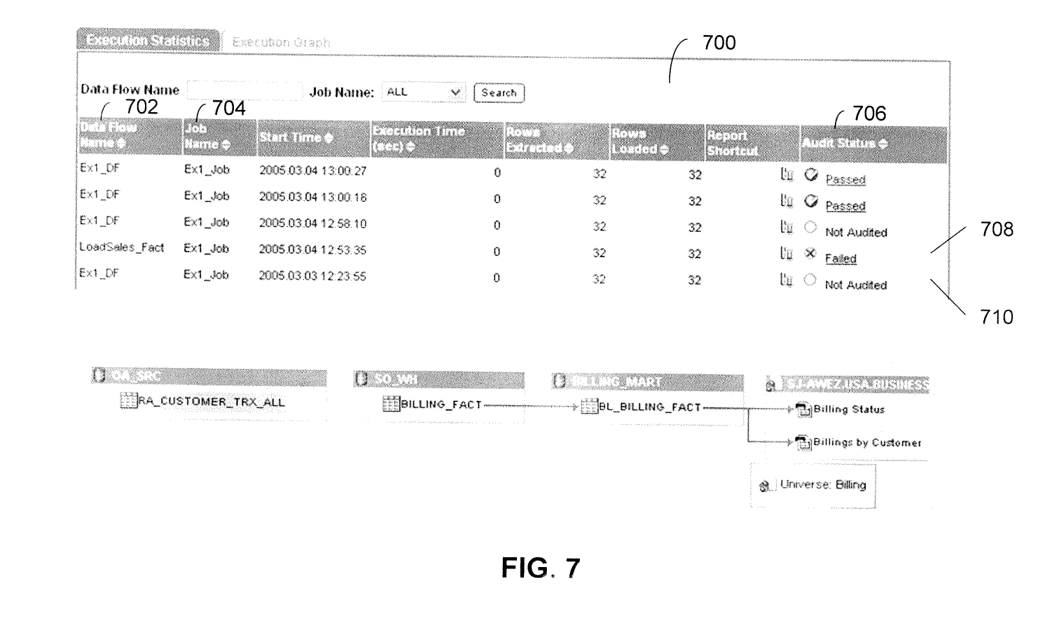

FIG. 7 illustrates a GUI 700 that specifies a set of data flows, including, a column 702 for data flow name and a column 704 for job name. The GUI 700 also includes an audit status column 706. For example, the audit status may specify if an audit failed 708 of if an audit has not transpired 710. The failed audit information may also be tied to information specifying the reports the failed audit impacts and the users of those reports. Thus, data trustworthiness may be assessed.

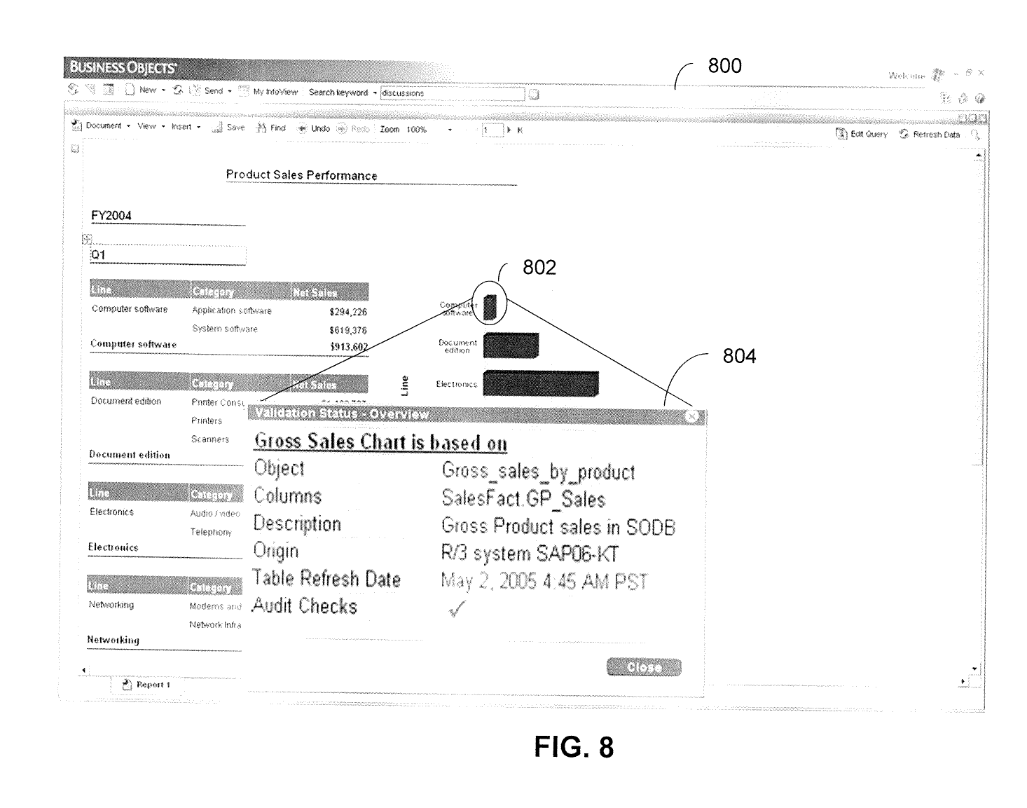

FIG. 8 illustrates a GUI 800 that facilitates an end user analysis of a quantity within a report. For example, by clicking on the quantity 802, validation status information is provided in screen 804. In this example, information is provided regarding an object name, column information, a quantity description, origin of the data, the refresh date of the data, and whether the data has been audited.

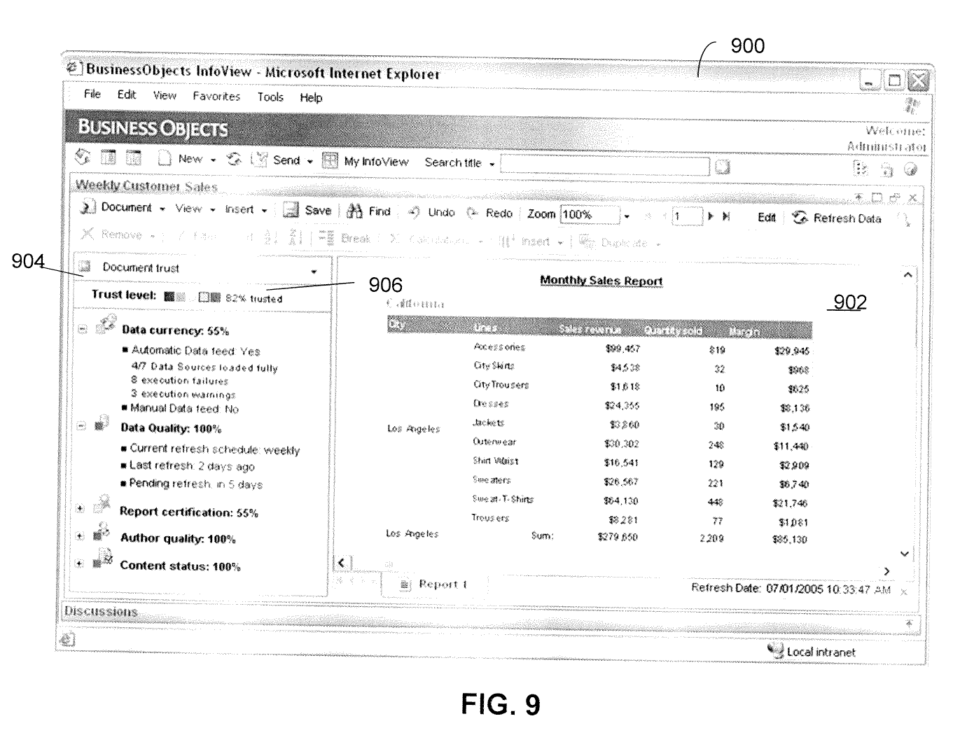

FIG. 9 illustrates a GUI 900 that displays a report 902 along with trust information 904. In this example, the trust information includes an overall trust level 906 depicted with color coded schema. The overall trust level may be a composite value based upon a data currency value, a data quality value, a report certification value, an author quality value, and a content status value, as shown in FIG. 9.

The invention is more fully appreciated in connection with some specific examples. In one embodiment, a Business Objects Metadata Manager (MM) provides an integrated view of metadata and its relationships across the entire Business Objects stack of products as well as third-party BI and ETL products.

Metadata integrators populate the MM repository with metadata objects, i.e. information about objects that reside in various types of source systems. Currently, relationships between one metadata object and another, other than the parent-child relationship, are contained in several different MM association tables. The MM user interface includes support for navigation of the natural object hierarchy, i.e., the parent-child relationship.

Relationship Analysis allows the user to see the relationships between one metadata object and another. Several relationship types are supported by MM including: Association, Source/Target, Is Same As, Hierarchy, and Is Related To. Some of these types have specific sub-types defined for them. A user can add sub-type definitions. Annotations may be attached to specific relationships. Parent-child relationships are captured in the MM object tables as part of an object's content.

In one embodiment, the invention consolidates multiple association tables into a single table called Relationship. Each row of this table identifies a relationship between two objects, with integrator configuration providing the relationship. A Relationship_Attribute table allows a user to add name-value pair attributes to specific relationships.

In one embodiment, the MM supports a range of relationships, including:
Parent-Child: A relationship in which an object has at most one parent. In one embodiment, this relationship is handled outside the domain of relationship management.
Association: Association is a relationship between two objects. A common kind of association is containment. Association is different from Parent-Child in the sense that the objects which are participating in association can associate with other objects (e.g., an open ended n-by-n relationship), whereas in the case of Parent-Child, a child can have only one parent. The relationship between a Relational_Table and a Relational_Column is Parent-Child; the relationship between Job and Dataflow is Association.
IS SAME AS: As the name suggests, this relationship equates two objects. A customer may define IS SAME AS relationships if the Integrator failed to do this or it is beyond MM application's logic to figure out that they are the same. IS SAME AS relationships are defined by integrators when processing ALIAS or SYNONYM names.
ALIAS/SYNONYM: These are sub-types of IS SAME AS. These relationships specify that an object in the Alias table is just an alias to or synonym of the referred object. Internally this means that the alias object has incomplete or no metadata and the application needs to use the metadata of the aliased object.
Source-Target: In this relationship one object feeds or loads data into another object. There can be an intermediate step in which the data is transformed. Hence, the Source-Target relationship also has an associated mapping table.
IS RELATED TO: This is a generic way that one can propose additional relationships to help understand and organize metadata. One defines new relationships among objects; these relationships are then sub categories of IS RELATED TO.
PrimaryKey-ForeignKey: This is a sub-type of IS RELATED TO. The object in the relationship is an object in the Foreign_Key table. The related object is the column in the Data_Element table that is a primary key column for the relational_table to which the foreign key refers.
Inheritance: In this relationship, the object in the relationship inherits attributes from the related object. Multiple inheritances are supported through this mechanism.

MM supports several relationship types as described in more detail in the following sections. These relationships exist between objects that are in the same integrator configuration, or also across integrator categories as well as across integrator configurations. Objects created by BI and RDB category integrators (such as the CMS Integrator and the like) are stored primarily in the MM Data Structure package tables. Objects created by ETL category integrators (such as the DI Integrator) fall primarily into the MM Data Transformation package tables. An example of a relationship that may extend across categories is the association between an ETL data flow and an RDB table that is used by the data flow. The common ground for forming relationships across integrator configurations and integrator categories is a Data_Element object (or a subtype of Data Element such as Relational_Column).

MM provides a mechanism to allow the customer to define equivalency in data structures through the use of the IS SAME AS relationship. The equivalency can be defined at any level within the data structure package, from the Data_Package table to the Data_Group table, to the Data_Element table, including subtypes of these tables. For example, relational table information loaded by the Integrator for table A can be defined to be equivalent to table DI_A loaded by the DI Integrator. The IS SAME AS relationship can only be defined between two objects of the same type, i.e., a Table object can not be the same as a Connection object.

In one embodiment of the invention, Relationship Management includes the following functionality.

| Name | Description |
|---|---|
| Physical Relationships | This has multiple sections. |
| Source-Target | This relationship is populated by an Integrator, but |
| | the customer can also create Source-Target |
| | relationships via the UI. |
| Association | Integrators define this relationship. This is generic in |
| | nature; the meaning will be specific to the business |
| | domain. As this is a generic type, the customer can |
| | not define this. |
| Inheritance | Integrators define this relationship. One example is |
| | the case of a Universe_Object inheriting from |
| | another Universe_Object. Customer cannot define |
| | this. |
| IS SAME AS | An Integrator populates this relationship for ALIAS |
| | and SYNONYM objects. The customer can equate |
| | two objects via the MM UI. |
| Alias/Synonym | This is a sub category of IS SAME AS. Integrators |
| | and customers both can create this type of |
| | relationship. |
| Parent-Child | This relationship is built into the data model and only |
| | Integrators can populate this relationship. |
| IS RELATED TO | This is the mechanism through which a customer |
| | proposes a new relationship between two objects. |
| PrimaryKey-ForeignKey | Integrators as well as customers can define this |
| | relationship. This is a sub-category of IS RELATED |
| | TO. |
| User input to Relationships | |
| Object Equivalency | This has a UI through which a customer proposes |
| | rules to equate an object or its children. |
| Preferences | Preference UI through which a customer sets his |
| | preferences. |
| Relationship engine | This is the kernel of the Relationship Management. |
| Populating relationships | This includes post-processing. |
| Establishing relationships | The engine interprets the user preferences and |
| | applies them to object equivalency rules to establish |
| | relationships between objects for IS SAME AS, IS |
| | RELATED TO, Impact and Lineage |
| User visible relationships | |
| Directory Browsing | Relationship management loads associated children |
| | for the browsing. |
| Impact & Lineage | UI aspect of Source-Target association. This can be |
| | an attribute of any relationship type or subtype. |
| Is Same As | Includes Alias and Synonym |
| Is Related To | Includes defining Primary Key-Foreign Key (PKFK) |
| | and user defined relationships |

The foregoing information is explained in more detail below.

1. Physical Relationship Types

There are two ways to establish relationship between objects
Integrator populating the relationship (includes post processing)
User defined
   a. Source-Target

The source-target relationships usually come from the ETL category, and always have the impact/lineage attribute. In a source-target relationship, source attributes are copied or transformed to become part of the target object's attributes. The source itself remains unchanged during this process, although the source could also have been the target of another source-target relationship. In the BI world, an example of a Source-target relationship can be seen between a relational column object and a report field object.

Each row in the Relationship table that represents a source-target relationship contains as the first object the source and the second object as a target. Note that a target may have several sources, and a source may have several targets. In this case there is one row for every source-target combination.

b. Association

An association relationship is considered to be a non-exclusive containment relationship. A parent-child relationship is considered to be an exclusive containment relationship.

Non-exclusive containment (association) means that the contained object may be part of multiple containers. For example, a DI Dataflow object may be used in more than one Job and/or more than one DI Workflow.

Each row in the Relationship table that represents an association relationship includes the object id of the container as the first object in the row and the object id of the contained or used object as the second object in the row. If Job A and Job B both contain Dataflow D, and Job B also contains Dataflow E, then there would be three rows in the Relationship table:
A, D
B, D
B, E
   c. PrimaryKey-ForeignKey

The MM repository contains a set of objects called Key. A Key is an identifier of an object. When identifying itself, the key is called a primary key. When identifying another object from an object, the key is called a foreign key. A relevant piece of information about a foreign key, in fact the only relevant information that is not identical to that of a primary key, is the table to which the foreign key refers. In fact, the foreign key may refer to multiple objects each of which has the same primary key value.

Each row in the Relationship table that represents a primary key/foreign key relationship includes the object id of the foreign key as the first object and the object id of the object to which the foreign key refers as the second object. If a foreign key refers to multiple objects, there will be one row for each of those objects.

d. Is-Same-As

This relationship means that two different objects in the MM repository are the same in the source system. The same object may have been imported into MM via different metadata integrators or integrator configurations.

This relationship can only exist between objects of the same type. This can happen, for example, if the RDBMS integrator is run against a specific database and the CMS integrator is run against a CMS system that contains objects that refer to tables in the same database as integrated by the RDBMS integrator. By definition, the is-same-as relationship can only be established by a knowledgeable user. If an integrator could have established that the is-same-as relationship exists, it would not have created the duplicate object in the first place. To minimize the amount of work that needs to be done by the user in identifying duplicate objects, the MM UI allows the user to identify the top of the two hierarchies in the is-same-as relationship. Then, all other objects in the same hierarchies with the same technical name and same parent would also be duplicates. In addition, IS SAME AS also supports two sub categories, ALIAS and SYNONYM as defined below.

e. Alias/Synonym

A synonym is another name for an object in the same namespace; an alias is another name for an object in a different namespace. For example, a synonym for a relational table exists in the same database as the table. An alias name in one database may refer to a relational table in a different database.

This relationship means that one object is a place holder for another object. This is recorded in the Relationship table as either an ALIAS or SYNONYM sub-category of the IS SAME AS relationship. In programming terms, this object is a pointer to another object. Most commonly an Alias or Synonym object has incomplete or no metadata. It depends upon the source (original) object for its metadata.

This means that whenever the Relationship engine sees an alias it needs to substitute the alias object's metadata with the source object's metadata. An Alias can refer to another Alias, which means they can be chained and to get the metadata the Relationship engine needs to traverse all the links and locate the source object. It is important to maintain the alias/synonym relationships to other aliases/synonyms for accurate reporting of impact analysis.

f. Parent-Child

A parent-child relationship is considered to be an exclusive containment relationship. An association relationship is considered to be a non-exclusive containment relationship. Parent-child relationships are not represented in the Relationship table. Instead, they are represented by the parentId property of an object. T he parent of an object may reside physically in the same table as the object itself or in a different table. Parent-child relationships may also be captured in the relationship table.

In a parent-child relationship, a parent may have several children, but a child has a single parent. The root object type of a parent-child hierarchy has no parent, but may have children.

2. User Input to Relationships

a. Preferences

The Preference UI is used to control the comparison of objects for impact and lineage. For example, a UI may specify:
[x] case sensitive
[x] Compare table
[x] Compare schema
[ ] Compare catalog
[ ] Compare Database
   This exemplary UI lets a user select the comparison criteria; by default it is comparing Schema, Table and Column, case sensitively. The Relationship engine depends on these criteria to find objects.
   b. Object Equivalency Rules

Object equivalency rules are important to the relationship engine. They are the rules which are used to determine which objects are the same across configuration (integrator source) boundaries. Object equivalency rules are user based input and hence have an associated UI. The following is a set of exemplary rules which a user may define.
For MS SQL Server user dbo is same as user sa and hence dbo.TableA is same as sa.TableA in a given catalog.
For MS SQL, Server if there is no owner specified, treat the owner as sa
And so on

3. User Visible Relationships

a. Directory Browsing

Currently, directory browsing only displays the natural hierarchy of objects, i.e., it traverses the parent-child relationships in the MM database. The root objects of each type of metadata integrator are specified in the integrator's integrator.xml file. From those roots, the natural hierarchy is followed as expressed in the single ObjectTypes.xml file that specifies the metadata object hierarchy as it is stored in the MM repository.

This SRS enhances directory browsing by adding association relationships that can participate in directory browsing. For example, a DI Job has a set of DI Workflow and Dataflow objects associated with it. This is not a parent-child relationship because the same Workflow and Dataflow objects can be used in other Jobs, and even in other Projects. However, it is an important usability feature for the user to be able to see that these Workflow and Dataflow objects are used by the Job when drilling down into the details of the Job.

b. Impact/Lineage

The notion of impact and lineage stems from source-target relationships. That is, if source A is used to create target B, then a change in A impacts B and B's lineage includes source A.

An impact relationship between two objects means that if one object is changed or deleted, there is an impact on the other object. “Object A impacts object B” means that a change in A or a deletion of A affects object B.

A lineage relationship between two objects indicates that one object is transformed from another object. “Object A is in the lineage of object B” means that all or part of object A is necessary in the construction of object B.

In effect, we see that the impact and lineage relationships, when examined between two objects, are in fact the same. What, then, is the difference between impact and lineage? The difference is in the direction of traversal starting from a given object. This is more easily seen when several objects are involved in the relationship. Suppose object A impacts object B, which impacts object C, which impacts object D; object E also impacts object C.

A→B→C→D
E→C
   We see then that the impact of changing C affects object D; E is not affected. However, the lineage of C is that it comes directly from B and E, and indirectly from A through B.

Impact and lineage, rather than being physical relationship types, are instead an attribute of a physical relationship type. In fact, impact and lineage can be an attribute of any physical relationship type. Whether or not impact/lineage is considered an attribute of any specific physical relationship between two object types is a matter of judgment, and can vary depending on the needs of the user.

Therefore, the MM user interface provides a methodology for the specification of whether the impact/lineage attribute should be applied to a given relationship type between two metadata object types.

MM provides a set of relationship types as discussed in the following section. Those relationship types are automatically entered into the Relationship table by the Metadata Integrators. In addition to those relationships, the user can define custom relationship types and can explicitly assign these relationships to MM objects.

Relationships recorded in the Relationship table may be added by the individual Integrator implementations. Integrators run a common post-processing operation that creates relationships and applies attributes that can be described generically by an Integrator-specific file.

Additional filtering and post-processing may be performed by various relationship-specific engines on the UI side.

B. Dependencies

The MM repository is created on a supported RDBMS (e.g., Microsoft SQL Server and Oracle). The MM UI may run under the Apache Tomcat application server.

C. Use Cases

1. User Defined Relationships—UI

a. IS SAME AS

Different application/integrator sources may refer to the same connection with different names. To indicate that these connections are the same, one can use the IS SAME AS relationship.

2. XML Specifications for Proposing Relationship

Consider the following cases.

The relationship between a Report field and a Report is that of parent child.
The relationship between a Universe object and Report field is an association.
Similarly, the relationship between Business field and Report field is an association.
Even though the above relationship does not fit the traditional source-target definition of impact, still we want to consider them in our impact and lineage analysis.
An XML specification gives a flexible way to propose which object relationship should be considered for Impact Lineage Analysis.
   3. Object Equivalency Rules

A common use case for an object equivalency rule is, in the case of a Microsoft SQL Server, the owner/schema name dbo and sa are the same. Even one creates an object from sa login, the SQL server sets dbo as the owner.

D. User Interactions

The following are the UI components used for relationship management in accordance with one embodiment of the invention.

| UI Name | Description |
|---|---|
| IS SAME AS | |
| Definition | User used this UI to define IS SAME AS relationship |
| Relationship analysis | This is the UI shown to user whenever he wants to see |
| | SAME objects. |
| IS RELATED TO | |
| Definition | This is the UI to define new relationships or user |
| | defined relationships. |
| Relationship analysis (PK-FK, | This is the UI shown to a user whenever he wants to |
| Impact, IS SAME AS) | see all the relationships available for a given object. |
| Object Equivalency Rule | UI to define Object Equivalency rule |
| Preference | UI to define global preference |
| MM Configuration | This is the UI to group two or more integrator sources |
| Management | to form a MM Configuration. This is part of |
| | administrator. |
| Impact and Lineage | Traditional Impact and Lineage. |

In sum, The Metadata Manager content is indexed to include object names, descriptions and other selected fields of that object. This indexing enables traditional searching for the metadata content. In other words, this aspect of the invention relates to supplying composite metadata for search purposes, not the actual search techniques used.

An extension to this basic search is a ‘relationship’ search. There are two parts to this—metadata based and data based relationships. The user's problem we are trying to solve is for the user to locate reports and or tables which might provide the user the information he or she is seeking. Consider the following examples:

| Search | | | Simple | Advanced |
|---|---|---|---|---|
| Term | Conditions | Return | Search | Search |
| Backlog | A report with Backlog | Report | Yes | — |
| | in its title | | | |
| Backlog | A report with Backlog | Report | Yes | — |
| | in its comments or | | | |
| | description | | | |
| Backlog | A report with a text | Report | Yes | — |
| | field in it containing | | | |
| | the word Backlog | | | |
| Backlog | a table or a column | Table/Column and all | No | Yes |
| | with the name backlog | reports which use that | | |
| | or description | Table/Column | | |
| | containing the term | | | |
| | backlog | | | |
| Backlog | a table or a column | Table/Column and all | No | Yes |
| | with the name backlog | views which use that | | |
| | or description | Table/Column and all | | |
| | containing the term | reports which use that | | |
| | backlog which is used | view. Repeats ad | | |
| | to create other SQL | infinitum | | |
| | views | | | |
| Backlog | a table or a column | Table/Column and all | No | Yes |
| | with the name backlog | the target tables and | | |
| | or description | columns using them | | |
| | containing the term | and the views and | | |
| | backlog which is a | reports derived from | | |
| | source column for | there | | |
| | target tables and | | | |
| | columns populated | | | |
| | either through an ETL | | | |
| | or an EII process | | | |
| Backlog | a table or a column | Table/Column and all | No | Yes |
| | with the name backlog | the target tables and | | |
| | or description | columns using them | | |
| | containing the term | and the views and | | |
| | backlog which is the | reports derived from | | |
| | ‘same as’ another table | there | | |
| Unilever | A report whose saved | Report | No | Yes |
| | data contains the word | | | |
| | ‘unilever’ | | | |
| Unilever | A column in a table | The column and all | No | Yes |
| | which contains the | downstream | | |
| | data ‘unilever’ | columns/views/reports | | |
| | | which depend on this | | |
| | | column | | |

E. Metadata-Based Relationships

In the above examples metadata relationships are used to influence search. The specific relationships used are:
Impact Analysis: when an object is found, the impact of that object on downstream objects (be they tables, views or reports) is followed; this helps return objects which may be more in line with the data format the user may want.
Same As: when an object is found, other representations of the same object are sought and the impact relationship for those objects is followed.
   F. Data-Based Relationships

For data-based search, data profiling is carried out by DI's engine. The profile results contain all the distinct values of a particular column. The data is then matched and all the related tables and reports are found. The specific relationships used are:
Impact Analysis
Primary Key—Foreign key relationships in case the data is from a table.
   Note that DI can profile on data saved within a report.

The integrator collects the Metadata information from different databases using a connection. The integrator collects the information regarding objects, such as Catalogs, Schemas, Tables, Views, Columns, Foreign Keys, Stored Procedures/Functions, Synonyms and Alias. The View's SQL creation is collected and parsed and then its dependent objects are stored in MM repository. (Catalogs are also known as Databases in some database management systems, such as Microsoft SQL Server).

G. Metadata Integrator

A new instance of the integrator can be configured using the Administrator module in a MM Web application or programmatically using a public SDK (Software Development Kit). For example, a Relational Database Management System (RDBMS) integrator accepts properties including:
Database type: Mandatory. If the database is an Oracle, SQL Server or DB2 instance.
Computer name: Mandatory. The name or IP of the computer installed database.
Database port number: Mandatory. The port number of the database service.
Service Name: Mandatory. The SID from TNS names, if the database is from Oracle.
Database Name: Mandatory. In case of DB2 or SQL Server databases, the name of the database the integrator should connect to.
Database User: Mandatory. The username of the connection.
Database Password: Optional. The password of the user database.
Table Schema: Optional. If it is set, the integrator imports the objects from this particular schema name (the name is case sensitive).

1. Objects Imported and Tree View

The RDB Integrator imports a tree of objects regardless of the database type. It follows a consistent structure to maintain a pattern regardless of the type of metadata being integrated (i.e., type of Integrator).

The tree of objects imported is:

Relational Database
Relational Catalog
   Relational Schema
      Relational Table
         Relational Column
      Relational View
         Relational Column
      Procedure (Including Functions)
         Procedure Parameters
      Synonyms

2. Tables/Views and Columns

The Tables are stored in MM Repository, along with their columns.

The Views are stored the same way as the table, except that it is persisted in a different table and has some post processing to create its relationships. For foreign key relationships, if there is a foreign key between a column table and another primary key column, it is imported as a PrimaryKeyForeignKey relationship between these two columns,

3. View and its Object Dependencies

The SQL statement that creates the view is stored as an attribute in the Relational View object.

This SQL is parsed and the components are persisted as follow:
Select Clause: The term is mapped like a DI Transformation, where the sources of the columns are the expression and the target columns are the view's columns.
   It is stored primarily based on the column dependency. (e.g. view column code depends on table Y column code.)
   The expression that generates the column is stored., optionally removing tile temporary columns references. e.g.: given the view:
select inner.code1∥‘-’∥t1.code code
from table1 t1,
   (select ‘Name:’ ∥t2.name code1
   from table2 t2) inner

The expression for column code in the view, removing the temporary inner table, may be:
Expression expanded: ‘Name:’ ∥table2.name∥‘-’∥table1.code
   It is created as a SourceTarget relationship, being as target the view columns and as source, the columns that participate to create the column of the view.

As an example, the previous SQL statement has one output column code, which is used as a target for two relationships, one for column table.code1 and another for the column table1.code.
From and Where Clauses: These clauses contain inner selects, views and table references. The relationships to these objects are extracted and stored in a separate relationship table, different from the Transformation in Select Clause.
Other clauses: The other clauses as Order by, Group by and Having clauses are ignored, because they do not contain objects other than those presented in the select clause.
Optionally, cross references are ignored. If some table or synonym from another database or schema is referenced, the process will not create a relationship between the view and this object.
If some statement has UNION clauses, creating more than one expression for one particular column, the multiple expressions are mapped in a unique expression separated by the word OR.
   For example,
select ‘Code:’ ∥code description
from table_codes
union all
select ‘Expose’ ∥anotherCode description
from another_table_code
   The expression mapped to the column description in the view should be:
‘Code:’ ∥code OR ‘Expose’ ∥anotherCode

4. Alias and Synonyms

The aliases and synonyms for tables and views are imported and are stored as relationships for real tables or views. Optionally, synonyms for procedures or functions are not stored.

In databases, Alias and Synonym can point other Alias and Synonyms. In this case, the Integrator transverses the chain until it reaches the referenced object. Then each alias or synonym points to the same object. Therefore, in MM there is no Synonym relationship where the target object is another synonym, and then just exists as target Tables and Views. The Alias and Synonyms are stored in MM as Synonym objects. A Synonym relationship between the Synonym object and the target object is created.

If there is an unresolved reference to a table or view, such as in the case when a table or view is located in a different schema or database, the table should be created under the right schema and database, but it can be empty as a placeholder.

In the case of public synonyms in Oracle, the relationship for the table is created under each schema when the schema is imported.

5. Functions and Procedures

The functions and procedures are stored as simple objects in MM, containing its schema, name and description.

Their parameters are collected and stored in the Procedure Parameters table. If the object is a function and returns a result, the result metadata is stored as a parameter in the first position.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-R()Ms and holographic de-ices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C#, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium., comprising executable to:
create a database structure that contains groups of linked data tables to store different types of metadata selected from Business Metadata, Structural Metadata and Operational Metadata;
receive at least two different types of metadata; and
populate the database structure with the at least two different types of metadata to form composite metadata.

2. The computer readable storage medium of claim 1 wherein the Business Metadata is information that characterizes data that is manipulated in a Business Intelligence system.

3. The computer readable storage medium of claim 1 wherein the Structural Metadata includes information to characterize the physical arrangement, characteristics and accessibility of data.

4. The computer readable storage medium of claim 1 wherein the Operational Metadata includes information that characterizes the utilization of a data source.

5. The computer readable storage medium of claim 1 wherein the different types of metadata are derived from at least two sources selected from a modeling tool source, an Extract Transform Load source, an Enterprise Information Integration source, a relational database source, and an Online Analytical Processing source.

6. The computer readable storage medium of claim 1 further comprising executable instructions to detect relationships between the at least two different types of metadata.

7. The computer readable storage medium of claim 1 further comprising executable instructions to produce a report from the composite metadata.

8. The computer readable storage medium of claim 1 further comprising executable instructions to analyze the composite metadata to establish and display a trustworthiness metric.

9. The computer readable storage medium of claim 8 further comprising executable instructions to display a data transformation associated with a selected data value.

10. The computer readable storage medium of claim 8 further comprising executable instructions to indicate a failed audit.

11. The computer readable storage medium of claim 8 further comprising executable instructions to display object information associated with a displayed data value.

12. The computer readable storage medium of claim 8 wherein the trustworthiness metric includes a data currency value.

13. The computer readable storage medium of claim 8 wherein the trustworthiness metric includes a data quality value.

14. The computer readable storage medium of claim 8 wherein the trustworthiness metric includes a report certification value.

15. The computer readable storage medium of claim 8 wherein the trustworthiness metric includes an author quality value.

16. A computer readable storage medium, comprising executable instructions to:
receive at least two sets of distinct metadata;
detect relationship types between the at least two sets of distinct metadata, wherein the relationship types include at least five of the following relationship types: source-target, association, inheritance, equivalence, alias, parent-child, related to, and primary key-foreign key; and
populate a database to store the relationship types and composite metadata corresponding to the at least two sets of distinct metadata.

17. The computer readable storage medium of claim 16 wherein the at least two sets of distinct metadata are selected from Business Metadata, Structural Metadata and Operational Metadata.

18. The computer readable storage medium of claim 16 wherein the at least two sets of distinct metadata are derived from at least two sources selected from a modeling tool source, an Extract Transform Load source, an Enterprise Information Integration source, a relational database source, and an Online Analytical Processing source.

19. The computer readable storage medium of claim 16 further comprising executable instructions to produce a report from the composite metadata.

20. The computer readable storage medium of claim 16 further comprising executable instructions to analyze the composite metadata to establish and display a trustworthiness metric.
